(19) United States
(12) Patent Application Publication
(10) Pub. No.: US 2014/0356471 A1
(43) Pub. Date: Dec. 4, 2014

(54) MOLDING ASSEMBLY HAVING POSITIONING MECHANSIM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YUAN-MING WANG, Shenzhen (CN); XUE-FENG WAN, Shenzhen (CN); YEN-WEN WANG, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/029,876

(22) Filed: Sep. 18, 2013

(30) Foreign Application Priority Data
Jun. 3, 2013 (CN) 201320312797X

(51) Int. Cl. B29C 45/14

(52) U.S. Cl. CPC B29C 45/14065
USPC 425/129.1

(57) ABSTRACT

A molding assembly for forming a product having an embedded member, includes an injection mold for molding the embedded member as a part of the product, and a positioning mechanism for positioning the embedded member in the injection mold. The injection mold has at least one first positioning post. The positioning member and the embedded member are integrally formed, and the positioning member defines a first hole for receiving the first positioning post to prevent the embedded member from offsetting in a first direction during the mold process of the product.

### BACKGROUND

1. Technical Field

The present disclosure relates to a molding assembly having a positioning mechanism for positioning an embedded member in an injection mold for molding a product.

2. Description of Related Art

Most electronic devices always include a number of components. Some components are molded by embedding one or more small inserts. However, during molding process, the small inserts may offset when the melted plastic is injected into the injection mold to form the component, which may result in the component being produced being unqualified.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the three views.

FIG. 1 is a disassembled view of a mold assembly for molding a product having an embedded member in accordance with an embodiment.

FIG. 2 is similar to FIG. 1, but viewed from another aspect.

FIG. 3 is a partial assembled view of the mold assembly of FIG. 1.

FIG. 4 is an assembled view of the mold assembly of FIG. 1.

FIG. 5 is a cross section view taken along line V-V of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

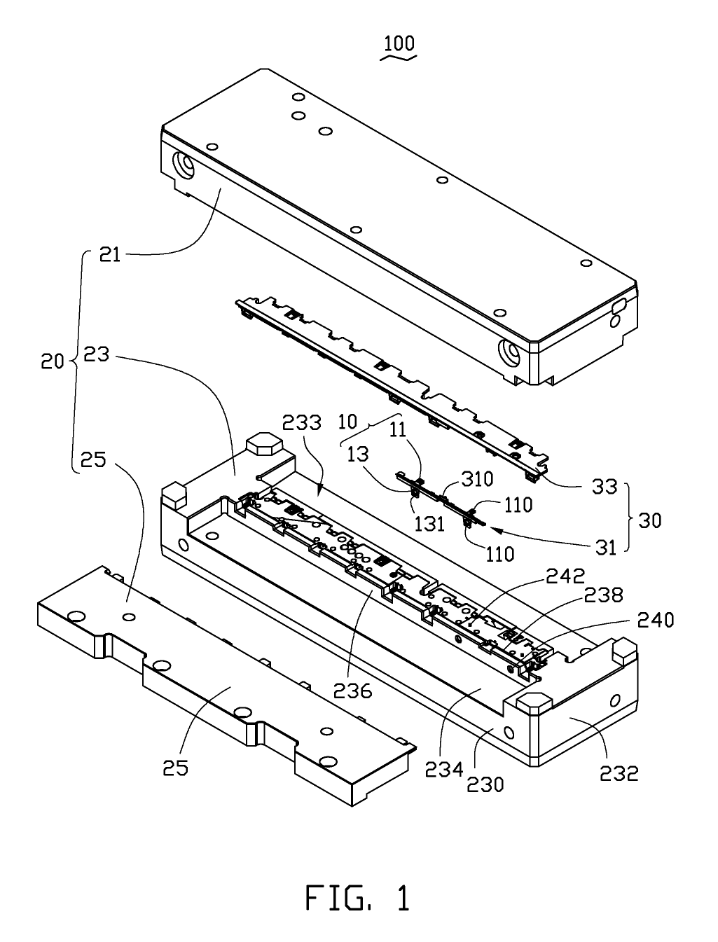

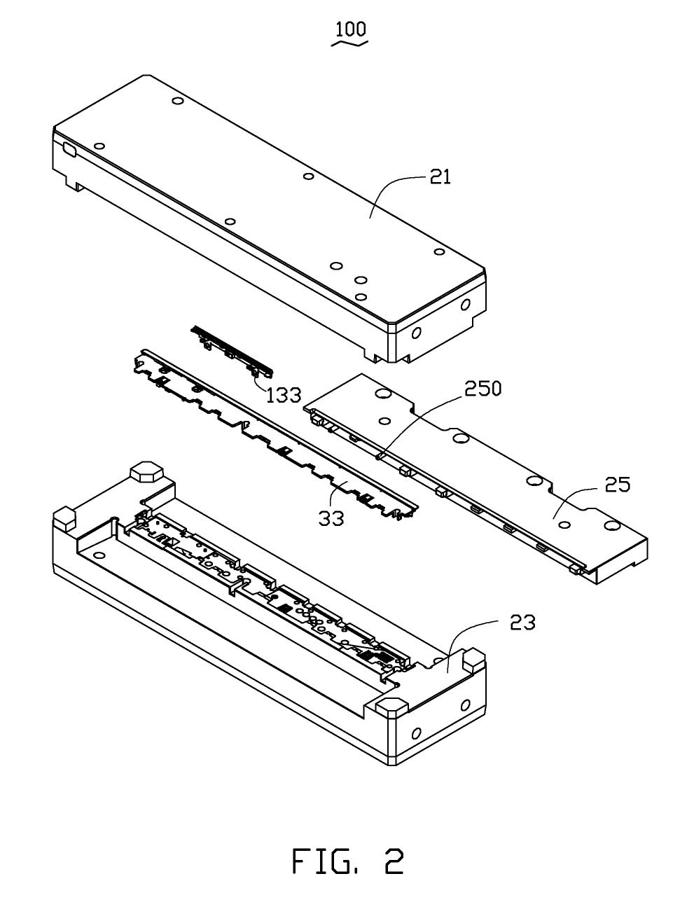

FIGS. 1-2 illustrate a molding assembly 100 for forming a product 30. The molding assembly 100 includes an injection mold 20, and a positioning mechanism 10 for positioning the product 30 in the injection mold 20 during the molding process. The product 30 includes an embedded member 31 and a to-be-molded portion 33. The embedded member 31 is previously molded or formed. The to-be-molded portion 33 is molded by the injection mold 20 and further molded together with the embedded member 31 to form the product 30.

The injection mold 20 is adapted to form the product 30. The injection mold 20 includes a first mold 21, a second mold 23 engaging with the first mold 21, and a sliding block 25. The first mold 21 is substantially rectangular. The second mold 23 is also substantially rectangular, and fittingly engages with the first mold 21. The second mold 23 includes a first sidewall 230 extending in a longitudinal direction. A top surface of the second mold 23 facing the first mold 21 defines a receiving space 233. A protruding block 236 protrudes from the bottom wall of the receiving space 233. The protruding block 236 is arranged parallel to the first sidewall and divides the receiving space 233 into two receiving portions, one of the receiving portions (referring herein as to the first receiving portion 234) is adjacent to the first sidewall 230. The protruding block 236 defines a receiving groove 238 for receiving the embedded member 31 and two through holes 240. The receiving groove 238 is defined at an end of the protruding block 236 and extends in a direction parallel to the first sidewall 230. The through holes 240 are defined at a sidewall of the protruding block 236 facing adjacent to the first sidewall 230 and communicating with the first receiving portion 234. Two first positioning posts 242 are secured to the protruding block 236. In the embodiment, the first positioning posts 242 are substantially cylindrical, and protrude from a surface of the protruding block 236 facing the first mold 21. The first posts 242 are aligned parallel to the first sidewall 230.

The sliding block 25 is slidably received in the first receiving portion 234, and is capable of moving relative to the second mold 23 in a direction perpendicular to the first sidewall 230. Two second positioning posts 250 are secured to an end of the sliding block 25 facing the protruding block 236. The second positioning posts 250 correspond to the through holes 240 respectively. A distal end of each second positioning post 250 is a substantially frustum, for guiding the second positioning posts 250 to be inserted into the corresponding through holes 240.

The positioning mechanism 10 is secured to the embedded member 31. In the embodiment, the positioning mechanism 10 and the embedded member 31 are integrally formed. The positioning mechanism 10 includes two first positioning members 11 and two second positioning members 13. The first positioning members 11 and the second positioning member 13 are arranged at opposite sides of the embedded member 31. The first positioning members 11 correspond to the first positioning posts 242, and are aligned parallel to the top surface of the protruding block 236. Each first positioning member 11 defines a first hole 110 for receiving the corresponding first positioning post 242. The second positioning members 13 are aligned parallel to a sidewall of the protruding block 236. The second positioning members 13 define two second holes 130 corresponding to the through holes 240 respectively. In the embodiment, the second positioning members 13 are made from plastic. The joint of each second positioning member 13 and the embedded member 31 define a substantially V-shaped recess to lessen the thickness of the joint to be less than 0.5 mm, to allow the second positioning member 13 to be removed from the product 30 after the product 30 has been molded.

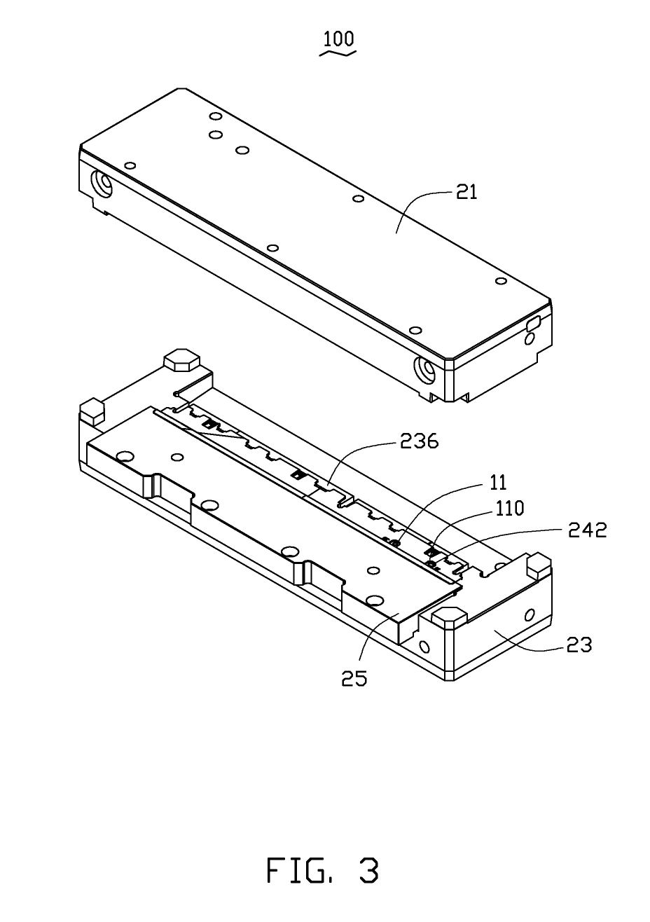

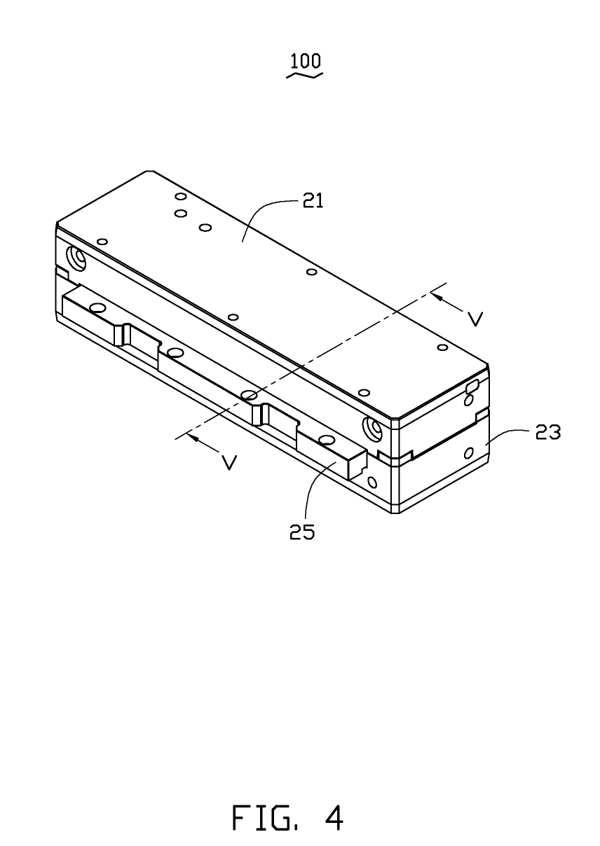

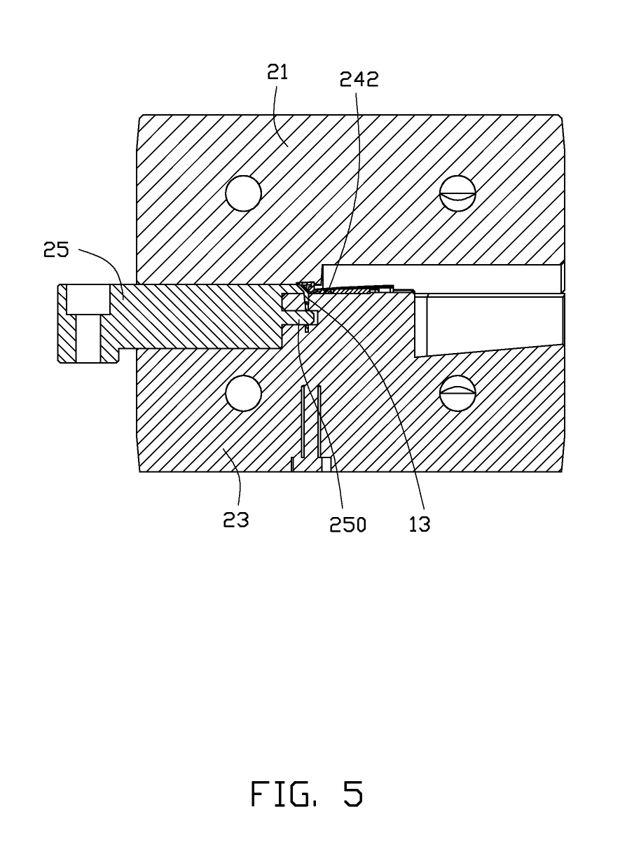

FIGS. 3-5 illustrate that to mold the product 30, the first positioning posts 242 are received in the corresponding first hole 110, and the second holes 130 corresponding to the through holes 240, to position the embedded member 31 to the protruding block 236. As a result, when melted plastic (not shown) is injected into the injection mold 20, the embedded member 31 is prevented from offsetting. To prevent the molded product 30 from being deformed in a first direction parallel to the top surface of the protruding block 236, the sliding block 25 is driven to slide toward the protruding block 236, and the second positioning posts 250 are inserted into the second holes 130 and the through holes 240. To prevent the molded product 30 from being deformed in a second direction perpendicular to the top surface of the protruding block 236, after the embedded member 31 and the to-be-molded member 33 are molded together to form the product 30, the second positioning members 13 are removed.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A molding assembly for forming a product having an embedded member, comprising:
an injection mold for molding the embedded member as a part of the product, the injection mold comprising at least one first positioning post; and
a positioning mechanism for positioning the embedded member in the injection mold;
wherein the at least one positioning member and the embedded member are integrally formed, the at least one positioning member define a first hole for receiving the at least one first positioning post to prevent the embedded member from offsetting in a first direction during the mold process of the product.

2. The molding assembly of claim 1, wherein the positioning mechanism further comprises at least one second positioning member for positioning the embedded member, to prevent the embedded member from deforming in a second direction different from the first direction during the mold process of the product.

3. The molding assembly of claim 2, wherein the injection mold further comprises at least one second positioning post, the at least one second positioning member defining a second hole for receiving at least one second positioning post to prevent the embedded member from deforming in the second direction.

4. The molding assembly of claim 3, wherein the at least one second positioning member and the embedded member are integrally formed.

5. The molding assembly of claim 4, wherein the at least one first and second positioning members are arranged at opposite sides of the embedded member and perpendicular to each other.

6. The molding assembly of claim 4, wherein the at least one second positioning member is removed after the product has been formed.

7. The molding assembly of claim 6, wherein a joint of the at least one second positioning member and the embedded member defines a recess to lessen the thickness of the joint.

8. The molding assembly of claim 2, wherein the injection mold further comprises a first mold, a second mold engaging with the first mold and defining a receiving portion, and a sliding block slideably received in the receiving portion, the at least one second positioning post is secured to the sliding block.

9. The molding assembly of claim 2, wherein the at least one second positioning member and the embedded member are made from plastic.
